(19) United States
(12) Patent Application Publication
(10) Pub. No.: US 2007/0265885 A1
(43) Pub. Date: Nov. 15, 2007

(54) Benchmarking system and method

(76) Inventor: Doug P. Cox, San Diego, CA (US)

Correspondence Address: DUCKOR SPRADLING METZGER & WYNNE;A LAW CORPORATION, 3043 4th Ave., SAN DIEGO, CA, 92103, US

(21) Appl. No.: 11/400,396

(22) Filed: Apr. 7, 2006

(51) Int. Cl. G06Q 40/00

(52) U.S. Cl. 705/4

(57) ABSTRACT

A method and system are disclosed. The method may include registering individuals online to be members of an online benefit plan management site, sending a form message to each of the members including a form requesting information regarding intermediary compensation, receiving a data message from at least one of the members including the requested intermediary compensation information, creating by means of a computer a database including the intermediary compensation information received in the data messages from the members, generating a customized intermediary compensation benchmarking report for the at least one of the members using the database, and sending a report message to the at least one of the members including the customized intermediary compensation benchmarking report.

### BACKGROUND OF THE INVENTION

1. Field of the Invention

The present invention relates in general to a method and apparatus for benchmarking. It more particularly relates to a method and system of benchmarking compensation, such as broker/consultant commissions, paid by an employer for employee benefit plans, such as employee insurance and other benefits.

2. Background Art

There is no admission that the background art disclosed in this section legally constitutes prior art.

Employers typically obtain insurance or other benefits using brokers or consultants, thereafter referred to as intermediaries. These intermediaries provide a service to the employers in regard to obtaining and maintaining their insurance policies for a commission that may be part of the total premium paid by the employer. These commissions may be paid directly to the intermediary by the employer or indirectly from the insurance carrier. Contingency commissions may also be available to the intermediary due to the number of policies or amount of premiums brought to the insurance carrier by the intermediary, for example.

Employers are not always aware of all the duties and services required to be performed by their intermediary, and the intermediary may not inform the employer of all of their duties, but merely let the employer deal directly with the insurance carrier. In addition the employer may not even be aware of the total amount of commissions paid to the intermediary, since the premiums may include an undisclosed commission that the carrier pays directly to the intermediary. Furthermore, the intermediaries set the amount of commissions for the policy, not the insurance carrier, and these commissions may vary greatly from one intermediary to another and have no relationship to the quality or quantity of service provided by the intermediary to the employer.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a block diagram of an embodiment of a benchmarking system of the present invention as an online membership site;

FIG. 2 is a block diagram of an embodiment of the communication with an employer as a member of the online site for the benchmarking system of FIG. 1;

FIG. 3 is a block diagram of an embodiment of the communication with an intermediary as a member or requester for the benchmarking system of FIG. 1;

FIG. 4 is a view of an embodiment of a form for requesting information from an intermediary; and

FIGS. 5A-F are views of an embodiment of a benchmarking report.

### DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

A method and system are disclosed for providing benchmarking information for compensation such as intermediary commissions for employee benefit plans. The method may include registering individuals online to be members of an online benefit plan management site, sending a form message to each of the members including a form requesting information regarding intermediary compensation, receiving a data message from at least one of the members including the requested intermediary compensation information, creating by means of a computer a database including the intermediary compensation information received in the data messages from the members, generating a customized intermediary compensation benchmarking report for the at least one of the members using the database, and sending a report message to the at least one of the members including the customized intermediary compensation benchmarking report.

In accordance with another disclosed embodiment of the invention, there is provided a method of providing benchmarking information, which may include creating by means of a computer a database from intermediary compensation information received from members of an online benefit plan management site, receiving a request message from a non-member requesting a customized intermediary compensation benchmarking report, sending a form message to the non-member including a form requesting intermediary compensation information, receiving a data message from the non-member including the non-members intermediary compensation information, generating the customized intermediary compensation benchmarking report for the non-member using the database, and sending a report message to the non-member including the customized intermediary compensation benchmarking report.

According to another aspect of a disclosed embodiment of the invention, there is provided a device for providing benchmarking information. The device may include means for registering individuals online to be members of an online benefit plan management site, means for sending a form message to each of the members including a form requesting intermediary compensation information, means for receiving a data message from at least one of the members including the intermediary compensation information, means for creating a database including the intermediary compensation information received in the data messages, means for generating a customized intermediary compensation benchmarking report for the at least one of the members using the database, and means for sending a report message to the at least one of the members including the customized intermediary compensation benchmarking report.

According to yet another aspect of a disclosed embodiment of the present invention, there is provided a device for providing benchmarking information. The device may include means for creating a database from intermediary compensation information received from members of an online employee benefit management site, means for receiving a request message from a non-member requesting a customized intermediary compensation benchmarking report, means for sending a form message to the non-member including a form requesting intermediary compensation information, means for receiving a data message from the non-member including the non-member's intermediary compensation information, means for generating the customized intermediary compensation benchmarking report for the non-member using the database, and means for sending a report message to the non-member including the customized intermediary compensation benchmarking report.

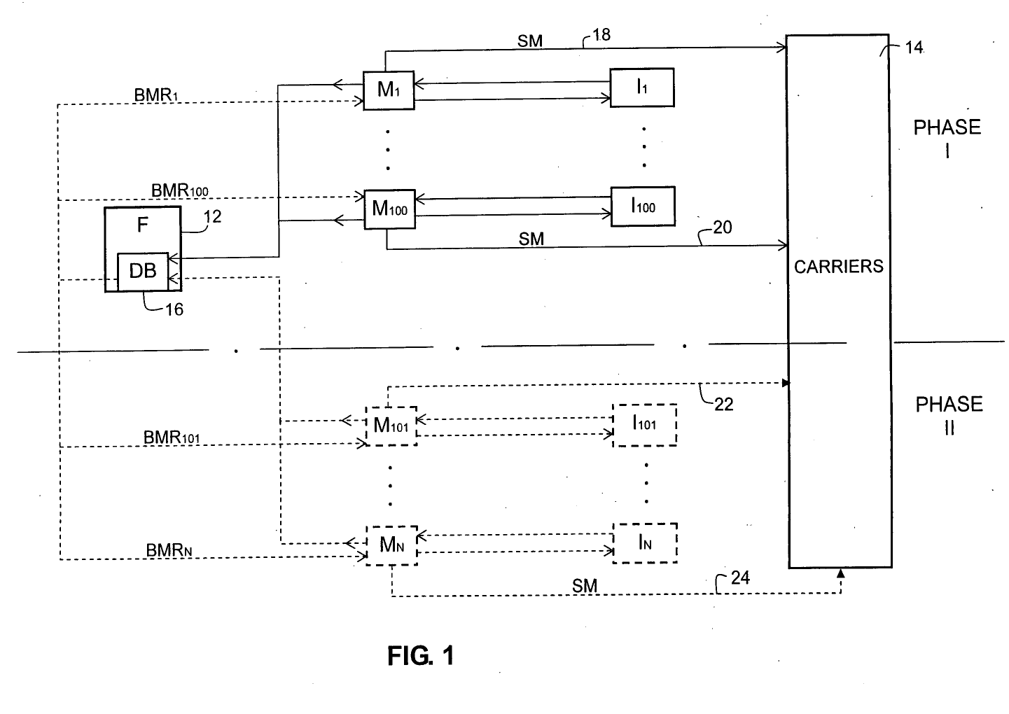

Referring to FIG. 1, an embodiment of the present invention as a benchmarking system is shown, generally referenced as 10. The benchmarking system 10 may be viewed in two phases, phase I and phase II. Phase I may be referred to as a start-up phase, and phase II as a benchmarking phase. Phase II is shown in dashed lines in FIG. 1.

During phase I or the start-up phase, a facilitator company 12 may create an online Internet site in which the facilitator registers employers M₁ through M₁₀₀ as members of their site for an annual fee based on the number of employees of the employer. One hundred members in phase I is only used as an example to illustrate this embodiment, the actual number of members during phase I may be greater than or less than 100. Each of the members M₁ through M₁₀₀ under the terms of their membership may request information from their intermediary I₁ through I₁₀₁, respectively, regarding intermediary compensation information on benefit packages obtained from carriers 14 for members M₁ through M₁₀₀. The benefit packages may include insurance policies, investment plans, or other employee benefit plans. The compensation information may include the name of the employer, the number of employees of the employer, commissions paid by the carrier, commissions paid by the employer, and contingent commissions, such as annual overrides, annual bonuses, etc.

The members M₁ through M₁₀₀ may then provide the compensation information received from the intermediaries I₁ through I₁₀₁, respectively, to the facilitator 12. The facilitator 12 may create a database 16 from the compensation information received from members M₁ through M₁₀₀.

Additionally through the online Internet site, the facilitator 12 may provide forms to be used by the members M₁ through M₁₀₀ to evaluate the performance of the intermediary I₁ through I₁₀₀, respectively, and/or to solicit proposals/information directly from the carriers 14 via solicitation messages 18 and 20, respectively, in order to self manage their employee benefit plans.

Phase I may continue until a point in time when the database 16 has a sufficient amount of information to provide benchmarking information. At this point in time, phase I may end and phase II or the benchmarking phase may begin.

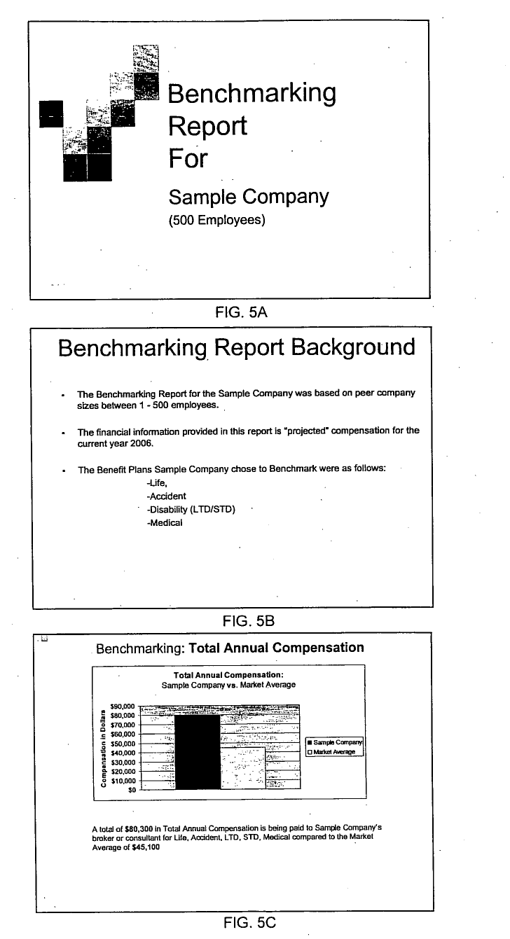

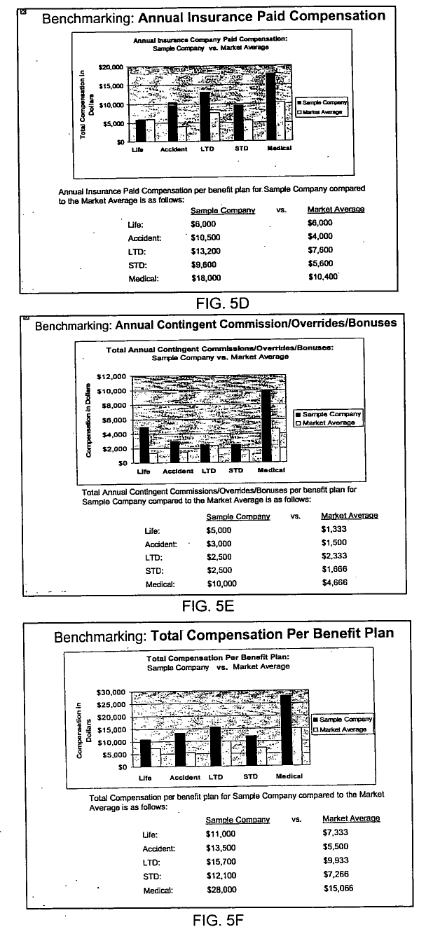

At the beginning of phase II, the facilitator 12 may begin preparing customized intermediary compensation benchmarking reports for each of the members M₁ through M₁₀₀. The customized intermediary compensation benchmarking report 60 (FIGS. 5A-F) may include a title page (FIG. 5A), background information regarding the member (FIG. 5B), a summary of all commissions/compensation paid to their intermediary for selected benefit plans compared to a market average of commissions/compensation paid to intermediaries for the selected benefit plans (FIG. 5C), a detailed view of the annual commission paid by the employer or the carrier for each of the selected plans compared to a market average of the annual commissions for each of the selected benefit plans (FIG. 5D), a detailed view of the annual contingent commissions paid by the carrier for each of the selected benefit plans compared to a market average of the contingent commissions for each of the selected benefit plans (FIG. 5E), and a detailed view of total compensation paid to the intermediary for each of the selected benefit plans compared to a market average of the total compensation paid to intermediaries for each of the selected benefit plans (FIG. 5F). The market averages or benchmarking information may be derived by facilitator 12 using the database 16 and may include commissions paid by employers of similar size to the member. Upon completion of the customized benchmarking reports, the facilitator may provide benchmarking reports BMR₁ through BMR₁₀₀ to the members M₁ through M₁₀₀, respectively.

The database 16 may be created and updated by the facilitator 12 by entering the information received from the members into a spreadsheet, such as Excel, according to the employer's name, size, and employee benefit plans selected to be benchmarked. The database 16 may include five categories of employer size, such as 1-500 employees, 501-2,500 employees, 2,501-5,000 employees, 5,001-10,000 employees, and 10,000+ employees. To prepare a customized intermediary compensation benchmarking report for a current employer, the facilitator may query the database 16 to match the current employer with other employers of similar size and selected benefit plans in the database 16. Next the facilitator may average the commissions/compensation of the matched employers to compute a market average. Bar charts may be created in the spreadsheet to present an easily recognized and understood format to the current employer. The bar charts and their originating information may then be transferred to a presentation format, such as PowerPoint, where the customized benchmarking report for the current employer may then be finalized.

Phase II may also include many of the activities described above in regards to phase I. As shown, the facilitator 12 may register additional members M₁₀₁ through M_{N}. The members M₁₀₁ through M_{N} may then request and receive compensation information from intermediaries I₁₀₁ through I_{N}, respectively. The compensation information from the intermediaries I₁₀₁ through I_{N} may be provided to facilitator 12. Upon receipt of the intermediary compensation information from one of the new members, such as member M₁₀₁, the facilitator 12 may add this intermediary compensation information to the database 16 and provide a customized intermediary compensation benchmarking report BMR₁₀₁ to member M₁₀₁. Likewise, each additional member may be provided a customized intermediary compensation benchmarking report after providing their intermediary commission information to the facilitator. The members M₁₀₁ through M_{N} may also solicit proposals/information directly from the carriers 14 via solicitation messages 22 and 24, respectively, in order to self manage their employee benefit plans.

In addition during phase II, employers that are not members of the online site may request a benchmarking report for a specific fee based on the number of benefit plans to be benchmarked.

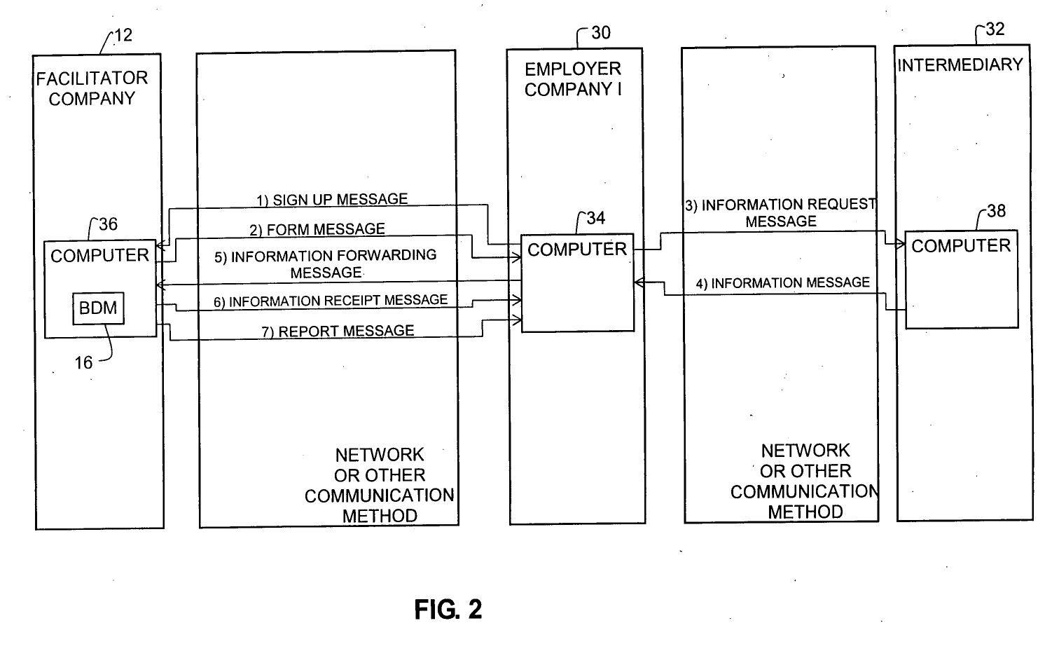

Referring now to FIG. 2, an embodiment of the communication in providing a customized benchmarking report to an employer is shown. The facilitator 12 may be providing a customized intermediary compensation benchmarking report to employer 30 in view of compensation received by a intermediary 32 in providing selected employee benefit plans to employer 30.

The employer 30 via a computer 34 may initiate the process by sending a sign-up message to a computer 36 of the facilitator 12 requesting to become a member of the online benefit plan management site or requesting a customized intermediary compensation benchmarking report without becoming a member. The sign-up message may include the employee benefits plans selected to be benchmarked. Upon receipt of the sign-up message, the facilitator 12 via the computer 36 may send a form message to the computer 34 of the employer 30 containing a compensation form to be completed by the intermediary 32.

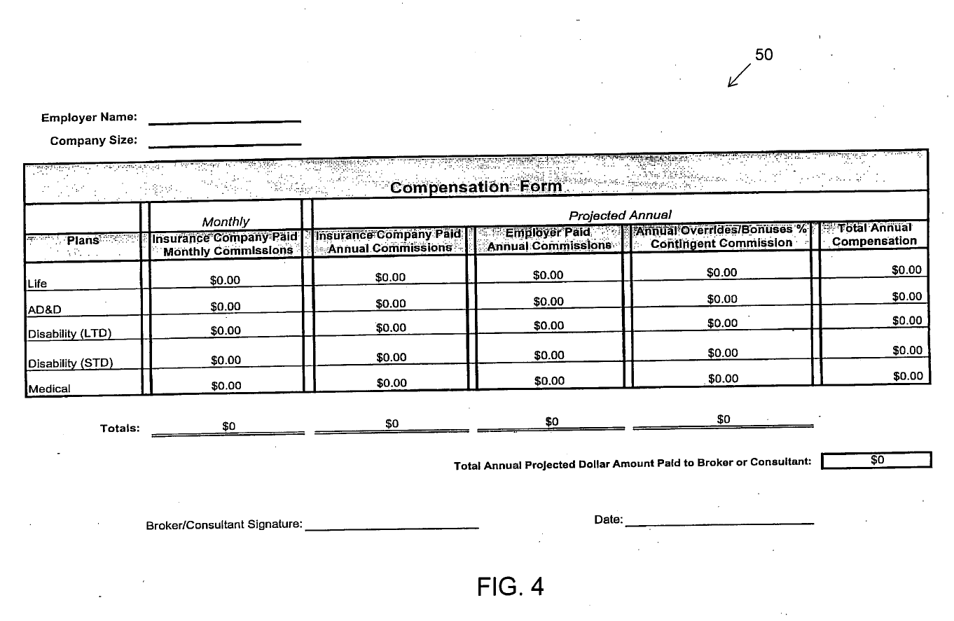

The compensation form 50 as shown in FIG. 4 may provide space for the intermediary to provide the employer's name, the employer's company size (number of employees), and compensation information for selected benefit plans, such as life insurance, accidental death and dismemberment insurance, long term disability insurance, short term disability insurance, medical insurance, etc. The compensation information may include monthly commissions paid by the insurance company, annual commissions paid by the insurance company, annual commissions paid by the employer, annual overrides/bonuses/contingent commissions, and total annual compensation. The intermediary may also sign and date the compensation form.

The employer 30 via the computer 34 may send an information request message containing the compensation form 50 to a computer 38 of the intermediary 32 requesting that the intermediary 32 complete and return the completed compensation form. The intermediary 32 may complete the compensation form 50 for the selected benefit plans and then send an information message with the completed form via the computer 38 to the computer 34 of the employer 30. The employer 30 via the computer 34 may then send an information forwarding message to the computer 36 of the facilitator 12 forwarding the completed compensation form from the intermediary 32.

Upon receipt of the completed compensation form from the employer 32, the facilitator 12 may update the database 16 by adding the information contained on the completed compensation form to the database 16 and may send an information receipt message via computer 36 to the computer 34 of the employer 30 acknowledging receipt of the completed compensation form and providing an estimated date for providing the employer 30 with a customized benchmarking report. The database 16 may be included in the computer 36 or included in a separate computer (not shown) in communication with the computer 36. If the employer 30 is registering as a member in phase I, the estimated date may be after the beginning of phase II as described above. If phase II has already begun, the facilitator 12 may then immediately begin preparing the customized intermediary compensation benchmarking report for the employer 30 based on the information presently available in the database 16. Upon completion of the customized intermediary compensation benchmarking report for the employer 30, the facilitator 12 via computer 36 may send a report message to the computer 34 of the employer 30 containing the customized intermediary compensation benchmarking report for employer 30.

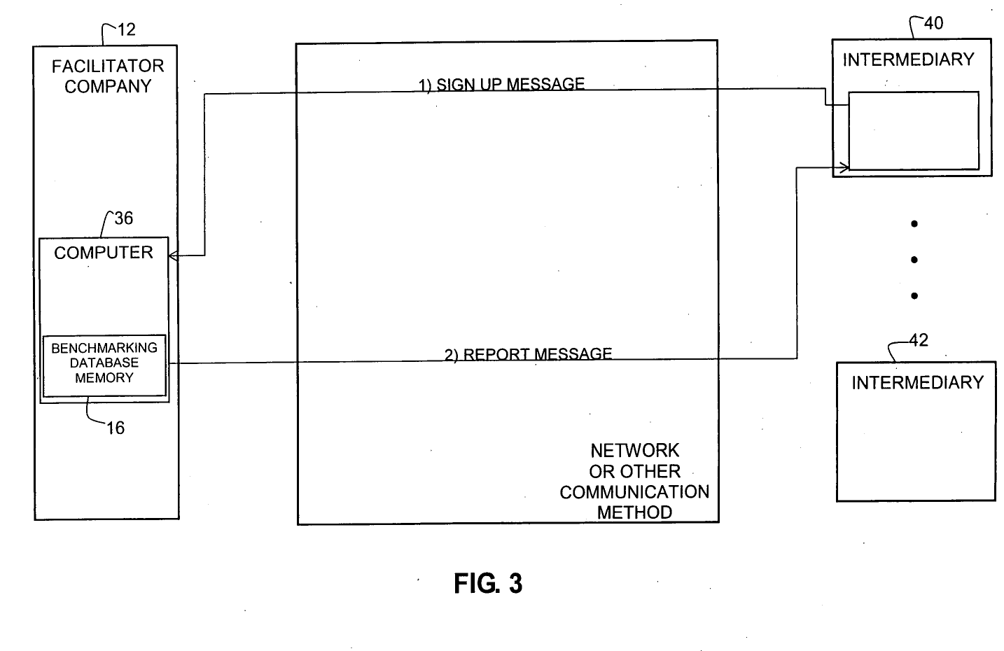

Referring now to FIG. 3, an embodiment of the communication in providing an intermediary-customized benchmarking report to an intermediary is shown. Intermediaries 40 and 42 may also register as members of the online site or request an intermediary-customized benchmarking report from the facilitator 12. The intermediary may become a member of the site in order to utilize the forms provided for communicating with their clients. The intermediary may obtain a benchmarking report to compare their commission/compensation to other intermediaries' commission/compensation.

The intermediary 40 via a computer 44 may initiate the process by sending a sign-up message to the computer 36 of the facilitator 12 requesting to become a member of the online site or requesting a customized benchmarking report without becoming a member. The sign-up message may include the employer size(s) and the employee benefits plan(s) selected to be benchmarked. Upon receipt of the sign-up message, the facilitator 12 may begin preparing the intermediary-customized benchmarking report for the intermediary 40 based on the information presently available in the database 16. Upon completion of the intermediary-customized benchmarking report for the intermediary 40, the facilitator 12 via computer 36 may send an intermediary report message to the computer 44 of the intermediary 40 containing the intermediary-customized benchmarking report for intermediary 40.

The network or other communication method shown in FIGS. 2 and 3 may be the Internet or some other electronic communication network. It may also include facsimiles, telephone communication, letters through the mail, or even personal contact.

The descriptions of the above embodiments involve the benchmarking the commission/compensation of intermediaries of employee benefit plans. However, it is envisioned that this method and system of benchmarking may be applicable the benchmarking of the commission/compensation to other service providers.

While particular embodiments of the present invention have been disclosed, it is to be understood that various different embodiments are possible and are contemplated within the true spirit and scope of the appended claims. There is no intention, therefore, of limitations to the exact abstract or disclosure herein presented.

What is claimed is:

1. A method of providing benchmarking information, comprising
registering individuals online to be members of an online benefit plan management site;
sending a form message to each of the members including a form requesting information regarding intermediary compensation;
receiving a data message from at least one of the members including the requested intermediary compensation information;
creating by means of a computer a database including the intermediary compensation information received in the data messages from the members;
generating a customized intermediary compensation benchmarking report for the at least one of the members using the database; and
sending a report message to the at least one of the members including the customized intermediary compensation benchmarking report.

2. The method of claim 1, further comprising
sending an information receipt message to the at least one of the members acknowledging receipt of the data message.

3. The method of claim 1, wherein at least one of the individuals represents an employer.

4. The method of claim 1, further comprising
registering an intermediary online to be a member of the online benefit plan management site;
generating an intermediary-customized benchmarking report for the intermediary using the database; and
sending an intermediary report message to the intermediary including the intermediary-customized benchmarking report.

5. The method of claim 4, wherein the intermediary is a broker of employee benefit plans.

6. The method of claim 4, wherein the intermediary is a consultant of employee benefit plans.

7. The method of claim 1, wherein the information includes an employer's name and number of employees, an employee benefit plan, and an amount of compensation paid to an intermediary for obtaining the employee benefit plan for the employer.

8. The method of claim 7, wherein the customized benchmarking report includes a comparison of the amount of the compensation and a market average of compensation for the employee benefit plan.

9. The method of claim 7, wherein the information is provided to the member by the intermediary.

10. The method of claim 8, wherein the intermediary is one of a group including a broker of employee benefit plans and a consultant of employee benefit plans.

11. The method of claim 1, wherein the database is created on a spreadsheet.

12. The method of claim 1, wherein the database includes a plurality of categories based on employer's size.

13. The method of claim 1, wherein the generating the customized intermediary compensation benchmarking report includes querying the database based on the at least one of the members' employer's size.

14. A method of providing benchmarking information, comprising
creating by means of a computer a database from intermediary compensation information received from members of an online benefit plan management site;
receiving a request message from a non-member requesting a customized intermediary compensation benchmarking report;
sending a form message to the non-member including a form requesting intermediary compensation information;
receiving a data message from the non-member including the non-members intermediary compensation information;
generating the customized intermediary compensation benchmarking report for the non-member using the database; and
sending a report message to the non-member including the customized intermediary compensation benchmarking report.

15. The method of claim 14, further comprising
sending an information receipt message to the non-member acknowledging receipt of the data message.

16. The method of claim 14, wherein the non-member represents an employer.

17. The method of claim 14, further comprising
receiving a request message from an intermediary requesting an intermediary-customized benchmarking report;
generating the intermediary-customized benchmarking report for the intermediary using the database; and
sending an intermediary report message to the intermediary including the intermediary-customized benchmarking report.

18. The method of claim 17, wherein the intermediary is a broker of employee benefit plans.

19. The method of claim 17, wherein the intermediary is a consultant of employee benefit plans.

20. The method of claim 14, wherein the information includes an employer's name and number of employees, an employee benefit plan, and an amount of commission paid to an intermediary for obtaining the employee benefit plan for the employer.

21. The method of claim 19, wherein the customized benchmarking report includes a comparison of the amount of the commission and a market average for that commission.

22. The method of claim 20, wherein the information is provided by the intermediary.

23. The method of claim 21, wherein the intermediary is one of a group including a broker of employee benefit plans and a consultant of employee benefit plans.

24. The method of claim 14, wherein the database is created on a spreadsheet.

25. The method of claim 14, wherein the database includes a plurality of categories based on employer's size.

26. The method of claim 14, wherein the generating the customized benchmarking report includes querying the database based on the non-member's employer's size.

27. A device for providing benchmarking information, comprising
means for registering individuals online to be members of an online benefit plan management site;
means for sending a form message to each of the members including a form requesting intermediary compensation information;
means for receiving a data message from at least one of the members including the intermediary compensation information;
means for creating a database including the intermediary compensation information received in the data messages;
means for generating a customized intermediary compensation benchmarking report for the at least one of the members using the database; and
means for sending a report message to the at least one of the members including the customized intermediary compensation benchmarking report.

28. The device of claim 27, wherein the information includes an employer's name and number of employees, an employee benefit plan, and an amount of compensation paid to an intermediary for obtaining the employee benefit plan for the employer.

29. The device of claim 27, wherein the customized intermediary compensation benchmarking report includes a comparison of the amount of the compensation and a market average of compensation for the employee benefit plan.

30. The device of claim 27, wherein the database is created on a spreadsheet.

31. The device of claim 27, wherein the database includes a plurality of categories based on employer's size.

32. The device of claim 27, further including means for querying the database based on the at least one of the members' employer's size.

33. A device for providing benchmarking information, comprising
means for creating a database from intermediary compensation information received from members of an online employee benefit management site;
means for receiving a request message from a non-member requesting a customized intermediary compensation benchmarking report;
means for sending a form message to the non-member including a form requesting intermediary compensation information;
means for receiving a data message from the non-member including the non-member's intermediary compensation information;
means for generating the customized intermediary compensation benchmarking report for the non-member using the database; and
means for sending a report message to the non-member including the customized intermediary compensation benchmarking report.

34. The device of claim 33, wherein the information includes an employer's name and number of employees, an employee benefit plan, and an amount of compensation paid to an intermediary for obtaining the employee benefit plan for the employer.

35. The device of claim 33, wherein the customized benchmarking report includes a comparison of the amount of the compensation and a market average of compensation for the employee benefit plan.

36. The device of claim 33, wherein the database is created on a spreadsheet.

37. The device of claim 33, wherein the database includes a plurality of categories based on employer's size.

38. The device of claim 33, further including means for querying the database based on the non-member's employer's size.
